(19) United States
(12) Patent Application Publication
(10) Pub. No.: US 2012/0013840 A1
(43) Pub. Date: Jan. 19, 2012

(54) DISPLAY APPARATUS AND REPAIR METHOD FOR REPAIRING THE SAME

(75) Inventors: Chun-Te Chang, Taoyuan County (TW); Po-Fu Huang, Taoyuan County (TW); Chih-Huang Chen, Taoyuan County (TW)

(73) Assignee: AU OPTRONICS CORPORATION, Hsinchu (TW)

(21) Appl. No.: 12/943,008

(22) Filed: Nov. 10, 2010

(30) Foreign Application Priority Data
Jul. 15, 2010 (TW) 99123274

(51) Int. Cl. G02F 1/13

(52) U.S. Cl. 349/192

(57) ABSTRACT

A display apparatus includes a display panel and a conductive adhesive. The display panel has a plurality of conductive lines and a dielectric layer covering the conductive lines. At least one of the conductive lines has an open defect. The dielectric layer has at least three repair vias, and locations of the repair vias correspond to the open defect. The conductive line having the open defect is exposed by at least parts of the repair vias. The conductive adhesive is disposed corresponding to a location of the open defect and electrically connected to the conductive line having the open defect through the repair vias. A repair method adapted to the display apparatus is also provided.

### CROSS-REFERENCE TO RELATED APPLICATION

This application claims the priority benefit of Taiwan application serial no. 99123274, filed on Jul. 15, 2010. The entirety of the above-mentioned patent application is hereby incorporated by reference herein and made a part of this specification.

### BACKGROUND OF THE INVENTION

1. Field of the Invention

The invention relates to an electronic apparatus and a repair method for repairing the electronic apparatus. More particularly, the invention relates to a display apparatus and a repair method for repairing the display apparatus.

2. Description of Related Art

Among displays, thin film transistor liquid crystal display (TFT-LCD) panels characterized by high definition, great space utilization, low power consumption, and no radiation have become the mainstream of the market.

In general, the TFT-LCD panel mainly has a display region, a circuit bonding region, and a plurality of conductive lines connecting the display region and the circuit bonding region. The conductive lines are located in an outer lead bonding (OLB) region of the display panel, for instance. When circuits in the OLB region are scratched, line defects may arise, or images cannot be well-displayed. Thereby, products may not be repairable and no longer be usable.

Due to open defects, one conductive line is divided into two line segments, and a cost-effective repair method exemplarily includes steps of respectively forming contact holes on the two line segments with use of laser and forming a dielectric layer on the two line segments. Namely, the contact holes exposing the two line segments are formed in the dielectric layer. A coating process is then performed with use of a conductive nano-gold/silver adhesive, and a baking process is carried out at 350° C. for approximately six minutes by using a thermal baking gun, so as to rectify the open defects. Namely, the conductive adhesive can be electrically connected to the two line segments through the contact holes, and thereby the two line segments can be electrically connected to each other through the conductive adhesive.

However, in order to form the contact holes in the dielectric layer for exposing the two line segments, it is necessary to adjust the power of laser based on the thickness of the dielectric layer. As such, problems of excessive power of laser penetrating the two line segments or insufficient laser power unable to form the contact holes exposing the two line segments can be prevented. Additionally, film layers (e.g. the dielectric layer) formed by different manufacturers have different thicknesses. Besides, laser power may be unstable or inaccurate. Hence, whether the contact holes can precisely expose the two line segments becomes rather difficult. In most cases, when the above-mentioned repair method is applied, 41.18% of the conductive lines can be successfully repaired. That is to say, to form the contact holes that can precisely expose the two line segments, the laser power must be modulated in consideration of other manufacturing conditions, which significantly increases the manufacturing time. Moreover, if the conductive adhesive is electrically connected to one contact hole on one of the two line segments instead of being electrically connected to the contact holes on the two line segments, it is likely to generate large resistance.

### SUMMARY OF THE INVENTION

The invention is directed to a display apparatus characterized by favorable electrical performance.

The invention is further directed to a repair method suitable for repairing a conductive line in the display apparatus, such that the display apparatus can have favorable electrical performance.

The invention provides a display apparatus including a display panel and a conductive adhesive. The display panel has a plurality of conductive lines and a dielectric layer covering the conductive lines. At least one of the conductive lines has an open defect. The dielectric layer has at least three repair vias, and locations of the repair vias correspond to the open defect. The conductive line having the open defect is exposed by at least parts of the repair vias. The conductive adhesive is disposed corresponding to a location of the open defect and electrically connected to the conductive line having the open defect through the repair vias.

The invention further provides a repair method adapted to a display panel. The display panel has a plurality of conductive lines and a dielectric layer covering the conductive lines. At least one of the conductive lines has an open defect. The repair method includes following steps. At least three repair vias corresponding to the open defect are formed in the dielectric layer, such that the conductive line having the open defect is exposed by at least parts of the repair vias. A conductive adhesive is formed at a location corresponding to the open defect, such that the conductive adhesive is electrically connected to the conductive line having the open defect through the repair vias.

Based on the above, the dielectric layer in the display apparatus of this invention has at least three repair vias whose locations correspond to the open defect of the conductive line, and the repair vias expose the conductive line having the open defect. Hence, when the conductive adhesive is disposed corresponding to the location of the open defect, the conductive adhesive can be electrically connected to the conductive line having the open defect through the repair vias, so as to repair the conductive line having the open defect. As such, even though a laser drilling process cannot be stably performed, or the dielectric layer covering the conductive lines has uncertain thickness, the conductive line having the open defect can be successfully and precisely repaired. The invention further provides the repair method for repairing the conductive line having the open defect. The repair method is adapted to the display apparatus, and the application of the repair method leads to favorable repair yield.

It is to be understood that both the foregoing general descriptions and the following detailed embodiments are exemplary and are, together with the accompanying drawings, intended to provide further explanation of technical features and advantages of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a display apparatus according to an embodiment of the invention.

FIG. 2A is a schematic partial view of one conductive line in the display apparatus depicted in FIG. 1.

FIG. 2B is a cross-sectional view illustrating the conductive line depicted in

FIG. 2A.

FIG. 2C and FIG. 2D are cross-sectional views illustrating the conductive line depicted in FIG. 2A in other types.

FIG. 3 is a schematic partial view of two conductive lines in the display apparatus depicted in FIG. 1.

FIG. 4A to FIG. 4B are schematic cross-sectional views illustrating a process of repairing one conductive line in the display apparatus depicted in FIG. 1.

FIG. 5 is a schematic cross-sectional view illustrating a process of repairing two conductive lines in the display apparatus depicted in FIG. 1.

### DESCRIPTION OF EMBODIMENTS

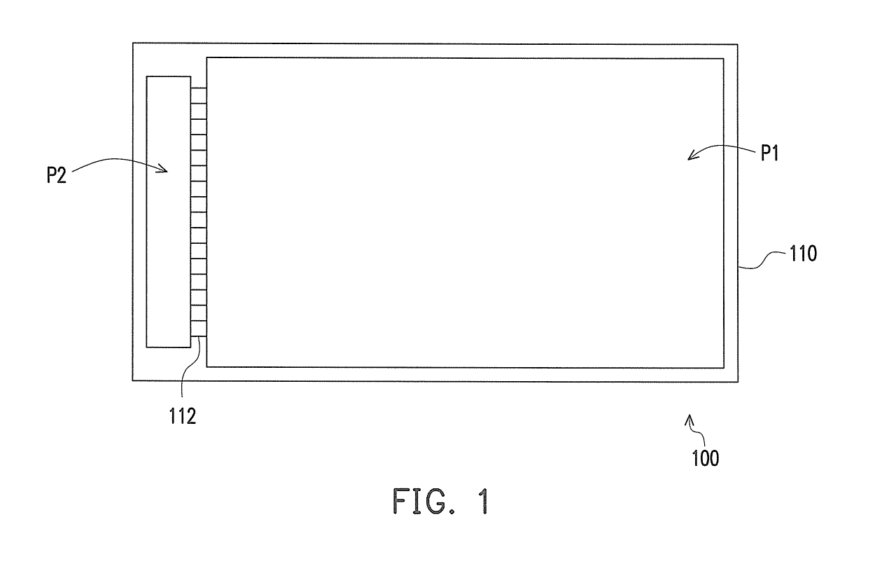

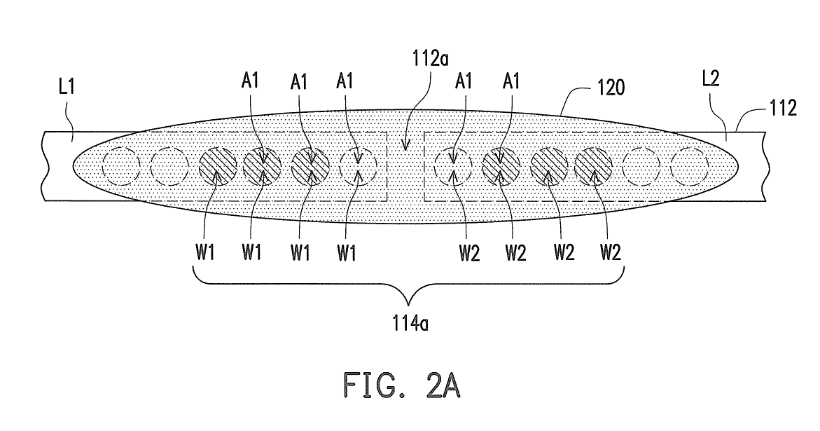

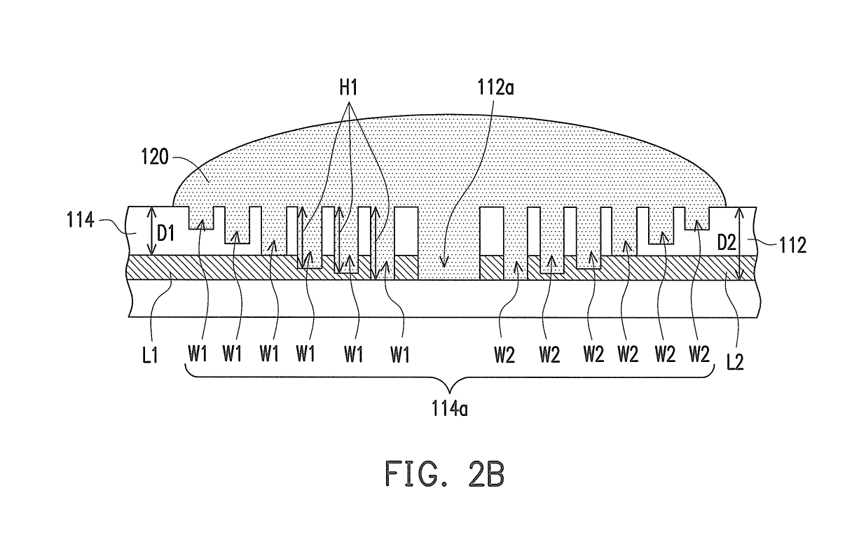

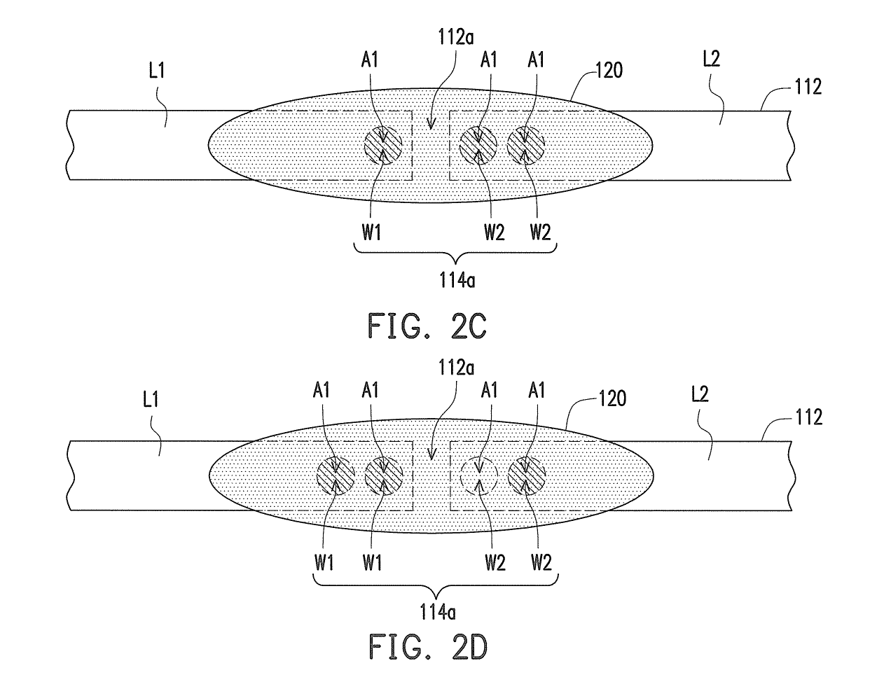

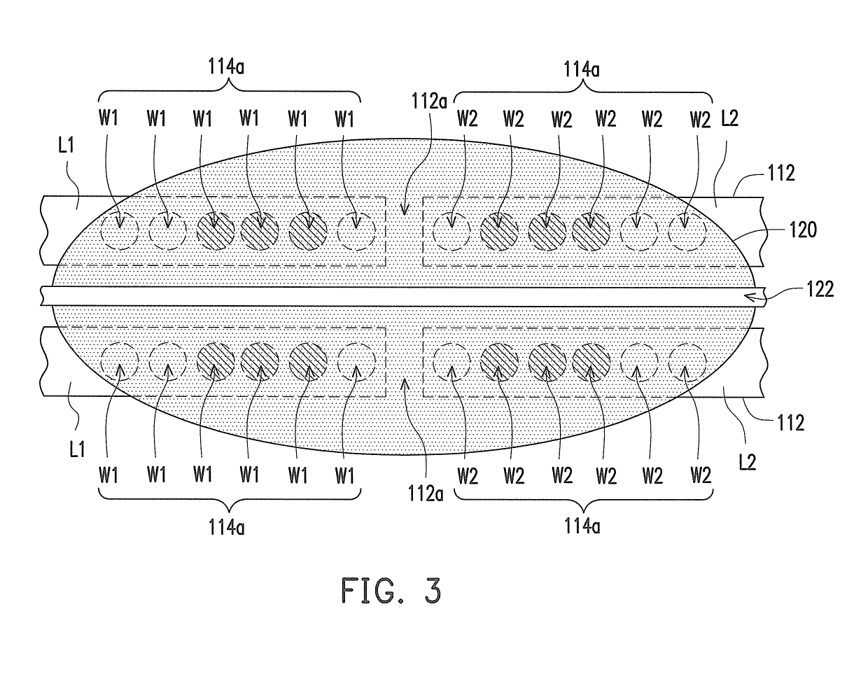

FIG. 1 is a schematic view of a display apparatus according to an embodiment of the invention. FIG. 2A is a schematic partial view of one conductive line in the display apparatus depicted in FIG. 1. FIG. 2B is a cross-sectional view illustrating the conductive line depicted in FIG. 2A. With reference to FIG. 1, FIG. 2A, and FIG. 2B, the display apparatus 100 of this embodiment includes a display panel 110 and a conductive adhesive 120. The display panel 110 has a plurality of conductive lines 112 and a dielectric layer 114 covering the conductive lines 112.

According to this embodiment, the display panel 110 has a display region P1 and a circuit bonding region P2 located outside the display region P1. The conductive lines 112 exemplified in this embodiment extend from the display region P1 to the circuit bonding region P2, for instance, which is not limited in this invention. In other embodiments of the invention, the conductive lines 112 can be generally referred to as scan lines or data lines in an active device array area or conductive lines in the circuit bonding region P2. The afore-mentioned display panel 110, for instance, is a liquid crystal display (LCD) panel, which is not limited in this invention. According to other embodiments of the invention, the display panel 110 can be an organic electro-luminescent display panel, a plasma display panel, an electro-phoretic display panel, or an electro-wetting display panel.

At least one of the conductive lines 112 in the display panel 110 has an open defect 112a, and the dielectric layer 114 covering the conductive line 112 has at least three repair vias 114a whose locations correspond to the open defect 112a, as indicated in FIG. 2A and FIG. 2B. To be more specific, when the conductive line 112 has the open defect 112a, the conductive line 112 is in an open state, such that electrical signals cannot be transmitted through the conductive line 112. Namely, the conductive line 112 having the open defect 112a is divided into a first line segment L1 and a second line segment L2, and the first and the second line segments L1 and L2 are separated from each other at a location of the open defect 112a. The conductive line 112 in FIG. 2A has one open defect 112a, for instance, which is however not limited in this invention. In other words, if possible, the conductive line 112 can have at least two open defects and can be divided into at least three line segments.

In FIG. 2A and FIG. 2B, the conductive line 112 is divided into the first line segment L1 and the second line segment L2 by the open defect 112a, and the repair vias 114a include m first repair vias W1 and n second repair vias W2. The m first repair vias W1 expose the first line segment L1 of the conductive line 112, and the n second repair vias W2 expose the second line segment L2. In this embodiment, the number of the repair vias 114a is greater than or equal to three, and thus m+n≧3.

Specifically, the number of the repair vias 114a is twelve (as exemplarily shown in FIG. 2A and FIG. 2B), whereas the invention is not limited thereto. In other embodiments of the invention, the number of the repair vias 114a can be properly determined based on design requirements. For instance, in can be equal to 1 (m=1), and n is greater than 1 (n>1). Alternatively, both m and n can be greater than 1 (m>1 and n>1). The value of m and n can be determined based on actual requirements. Note that advantages described hereinafter can be achieved only if the number of the repair vias 114a is greater than or equal to three.

With reference to FIG. 2A and FIG. 2B, the repair vias 114a (W1 and W2) of this embodiment can have the same depth H1 or different depths H1. At least parts of the repair vias 114a (W1 and W2) have the depths H1, each of which is greater than a thickness D1 of the dielectric layer 114. Accordingly, the conductive line 112 having the open defect 112a can be exposed by the repair vias 114a of the dielectric layer 114. In particular, if the repair vias 114a are formed by performing a laser drilling process, the repair vias 114a having different depths H1 can be formed by adjusting power of laser. Here, the repair vias 114a having different depths H1 can be arranged in different order based on design requirements. To better describe the invention, the repair vias 114a of this embodiment are arranged in a specific sequence as provided below, which should not be construed as a limitation to this invention.

In detail, the repair vias 114a are mainly utilized to repair the conductive line 112 having the open defect 112a, such that the conductive line 112 can continue to transmit electrical signals. Thus, locations of the repair vias 114a often correspond to the open defect 112a. In the embodiment depicted in FIG. 2A and FIG. 2B, a method of forming the repair vias 114a having different depths H1 by performing the laser drilling process can include steps of applying relatively strong laser power to the repair vias 114a close to the open defect 112a and applying reduced laser power to the repair vias 114a away from the open defect 112a, such that the repair vias 114a close to the open defect 112a have greater depths H1, and the repair vias 114a away from the open defect 112a have smaller depths H1. Namely, the repair vias 114a having the different depths H1 can be arranged along an extending direction of the conductive line 112 having the open defect 112a.

In another embodiment of the invention, the repair vias 114a having the different depths H1 may not be arranged as shown in FIG. 2A and FIG. 2B. For instance, relatively weak laser power can be applied to the repair vias 114a close to the open defect 112a, and laser power applied to the repair vias 114a away from the open defect 112a can be gradually increased, such that the repair vias 114a close to the open defect 112a have smaller depths H1, and the repair vias 114a away from the open defect 112a have greater depths H1. In addition, the repair vias 114a having the different depths H1 can be arranged not only in the above-mentioned manner but also in a random manner. That is to say, the repair vias 114a having the different depths H1 can be arranged based on users' preference or requirements, which should not be construed as a limitation to this invention.

It should be mentioned that the repair vias 114a described above have the different depths H1, while the depths H1 of the repair vias 114a in other embodiments of the invention can also be the same or partially the same. Similarly, the depths H1 of the repair vias 114a are determined based on users' preference or requirements, which should not be construed as a limitation to this invention.

Besides, as shown in FIG. 2A and FIG. 2B, the conductive line 112 having the open defect 112a has areas A1 exposed by the repair vias 114a, and the exposed areas A1 are substantially the same, given that the width of laser is properly adjusted. In another embodiment of the invention, the exposed areas A1 may also be different from one another, or some of the exposed areas A1 are the same while the others are different. The exposed areas A1 are the same in this embodiment, which should not be construed as a limitation to this invention. It should be mentioned that the depths H1 of the repair vias 114a and the exposed areas A1 can be determined at will based on the descriptions provided above. For instance, the depths H1 of the repair vias 114a can be the same, partially the same, or different, and the repair vias 114a can be arranged in a specific manner as described above or in a random manner. Besides, the areas A1 exposed by the repair vias 114a can be the same, partially the same, or different. The depths H1 of the repair vias 114a, the arrangement of the repair vias 114a, and the areas A1 exposed by the repair vias 114a described above are merely exemplary and can be determined at will based on actual requirements.

To better explain the technical features of the invention, the thickness of the dielectric layer 114 is D1 in this embodiment, and the total thickness of the dielectric layer 114 and the conductive line 112 having the open defect 112a is D2, for instance. As such, in order for the dielectric layer 114 to properly expose the conductive lines 112, the depths H1 of at least parts of the repair vias 114a range from D1 to D2. In FIG. 2B, some of the repair vias 114a (W1 and W2) away from the open defect 112a can have the depths H1 smaller than D1, and the other repair vias 114a (W1 and W2) close to the open defect 112a can have the depths H1 substantially equal to D2.

As indicated in FIG. 2A and FIG. 2B, the conductive adhesive 120 is disposed corresponding to the location of the open defect 112a. Since the conductive line 112 having the open defect 112a can be exposed by the repair vias 114a of the dielectric layer 114, the conductive adhesive 120 can be electrically connected to the conductive line 112 having the open defect 112a through the repair vias 114a.

To be more specific, the conductive line 112 has the open defect 112a, and therefore the conductive line 112 is divided into the first line segment L1 and the second line segment L2 (shown in FIG. 2A and FIG. 2B) and broken. As such, electrically signals cannot be transmitted through the conductive line 112. To conduct the conductive line 112 for transmission of electrical signals, first repair vias W1 on the first line segment L1 expose the first line segment L1, and second repair vias W2 expose the second line segment L2. As such, when the conductive adhesive 120 is disposed at and near the open defect 112a, the conductive adhesive 120 can come into contact with the first line segment L1 and the second line segment L2 respectively through the first repair vias W1 and the second repair vias W2. Thereby, the first line segment L1 and the second line segment L2 can be electrically connected to each other through the conductive adhesive 120.

Note that the total number of the first repair vias W1 and the second repair vias W2 of the repair vias 114a is three or more. This is because the time that is spent on forming the required depths of the repair vias 114a by performing the laser drilling process can be reduced if the number of the repair vias 114a is three or more. If there are at least three of the first and the second repair vias W1 and W2 successfully exposing the conductive line 112, the resistance of the conductive adhesive 120 and the first and the second line segments L1 and L2 can be further decreased. In general, to form the repair vias in the dielectric layer for exposing the first and the second line segments, it is necessary to adjust power of the laser based on the thickness of the dielectric layer. As such, problems of excessive laser power penetrating the first and the second line segments or insufficient laser power unable to form the repair vias exposing the first and the second line segments can be prevented. Namely, to precisely form the repair vias exposing the first and the second line segments, it is necessary to modulate the required laser power, which leads to an increase in the test time during the fabrication process.

By contrast, the number of the repair vias 114a in this embodiment is three or more, and the depths H1 of the first and the second repair vias W1 and W2 respectively located on the first and the second line segments L1 and L2 are decreased when the locations of the first and the second line segments L1 and L2 are away from the open defect 112a. Accordingly, it can be learned that strong laser power can be applied to form the first and the second repair vias W1 and W2 that are close to the open defect 112a and have greater depths H1. Here, the depth H1 can be the thickness D2. Laser power is then gradually reduced along a direction away from the open defect 112a, so as to form the first and the second repair vias W1 and W2 with different depths, as shown in FIG. 2B. In other words, the repair vias having different depths are formed at different times by modulating the laser power in this embodiment. At least parts of the repair vias 114a respectively expose the first and the second line segments L1 and L2, such that the first and the second line segments L1 and L2 can be conducted by the conductive adhesive 120 when the conductive adhesive 120 is disposed on the dielectric layer 114. As such, in the display apparatus 100 having the repair vias 114a, the test time during the fabrication process can be reduced.

In the display apparatus 100, the conductive adhesive 120 may cover the repair vias 114a and can be made of a thermal-curable conductive adhesive or a photo-curable conductive adhesive.

In FIG. 2A and FIG. 2B, the number of the repair vias 114a is twelve, for example, while the number of the repair vias 114a in another embodiment of the invention can also be three, as shown in FIG. 2C. Since the number of the repair vias 114a in FIG. 2C is three, and the three repair vias 114a expose the first line segment L1 and the second line segment L2, the conductive adhesive 120 can come into contact with the first line segment L1 and the second line segment L2 through the repair vias 114a when the conductive adhesive 120 is disposed corresponding to the location of the open defect 112a. Thereby, the first line segment L1 and the second line segment L2 can be electrically connected to each other through the conductive adhesive 120. On the other hand, the contact area between the conductive adhesive 120 and the conductive line 112 is increased because the three repair vias 114a all expose the conductive line 112. As such, the open defect of the conductive line 112 is rectified, conductivity of the repaired conductive line 112 is increased, and resistance is reduced.

In still another embodiment of the invention, the number of the repair vias 114a can be four, as indicated in FIG. 2D. Two second repair vias W2 located at the second line segment L2 as depicted in FIG. 2D can be used to test and determine the proper amount of laser power for exposing the second line segment L2 without destroying the second line segment L2, and two first repair vias W1 are formed on the first line segment L1 with use of the laser whose power is sufficient to expose the second line segment L2. Similarly, the contact area between the conductive adhesive 120 and the conductive line 112 is increased because at least three repair vias 114a expose the conductive line 112. As such, the open defect of the conductive line 112 is rectified, conductivity of the repaired conductive line 112 is increased, and resistance is reduced.

The conductive line 112 has one open defect 112a in the previous embodiments, and the following embodiment is directed to at least two conductive lines which have the open defects and can still be repaired.

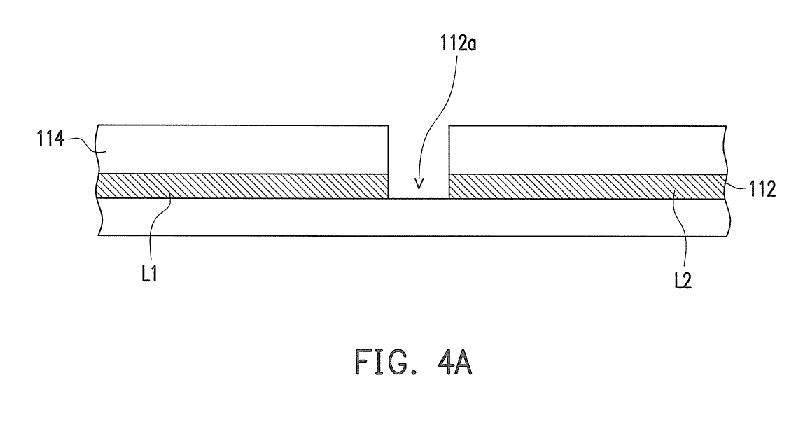

In an embodiment of the invention, if two adjacent conductive lines 112 of the conductive lines 112 have adjacent open defects 112a as shown in FIG. 3, the conductive adhesive 120 may cover the open defects 112a of the two conductive lines 112. Besides, the conductive adhesive 120 has a cutting trench 122 between the two conductive lines 112, so as to prevent short circuit between the two conductive lines 112 because of the conductive adhesive 120. It should be mentioned the two conductive lines 112 having the open defects 112a as shown in FIG. 3 can also have a plurality of repair vias that are formed in the way depicted in FIG. 2B. Relevant descriptions are described above and will not be repeated herein.

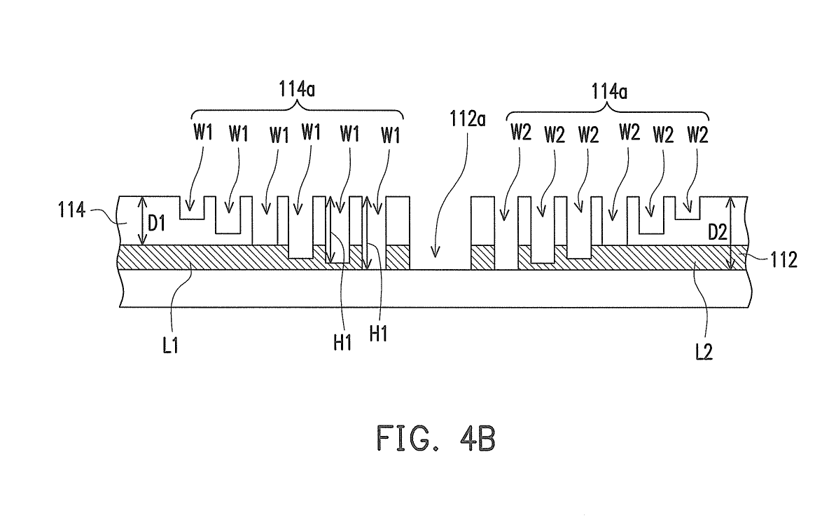

Based on the above, a repair method adapted to the display panel 110 is provided in this embodiment. FIG. 4A to FIG. 4B are schematic cross-sectional views illustrating a process of repairing a conductive line. The repair method of this embodiment includes following steps. The conductive line 112 having the open defect 112a as shown in FIG. 4A is found or provided.

At least three repair vias 114a corresponding to the open defect 112a are formed in the dielectric layer 114, such that the repair vias 114a expose the conductive line 112 having the open defect 112a, as shown in FIG. 4B. In this embodiment, a method of fanning the repair vias 114a is laser drilling as described above, for example. To form individual repair vias 114a having different depths H1 as indicated in FIG. 4B, the laser power consumed in the laser drilling process is modulated one by one, for instance, so as to form the repair vias 114a along an extending direction of the conductive line 112 having the open defect 112a. In addition, areas irradiated by laser can be modulated in the laser drilling process to determine the areas A1 exposed by the repair vias 114a as indicated in FIG. 2A, and the repair vias 114a having different dimensions can be formed along the extending direction of the conductive line 112 having the open defect 112a. Here, the different dimensions of the repair vias 114a denote the different areas A1 exposed by the repair vias 114a.

According to this embodiment, in the method of forming the repair vias 114a, at least parts of the repair vias 114a have the depths H1, each of which is greater than the thickness D1 of the dielectric layer 114. Thereby, the first line segment L1 and the second line segment L2 of the conductive line 112 having the open defect 112a can be exposed, as shown in FIG. 4B or FIG. 2B.

The conductive adhesive 120 corresponding to the open defect 112a is formed, such that the conductive adhesive 120 can be electrically connected to the conductive line 112 having the open defect 112a through the repair vias 114a, as shown in FIG. 2B. In this embodiment, a method of forming the conductive adhesive 120 can be determined based on the material of the conductive adhesive 120. For instance, if the conductive adhesive 120 is the thermal-curable conductive adhesive, the conductive adhesive 120 can be cured by heating when the conductive adhesive 120 is dispensed corresponding to the location of the open defect 112a. If the conductive adhesive 120 is the photo-curable conductive adhesive, the conductive adhesive 120 can be cured by irradiation when the conductive adhesive 120 is dispensed corresponding to the location of the open defect 112a. The repair method for repairing the conductive line 112 is substantially completed so far.

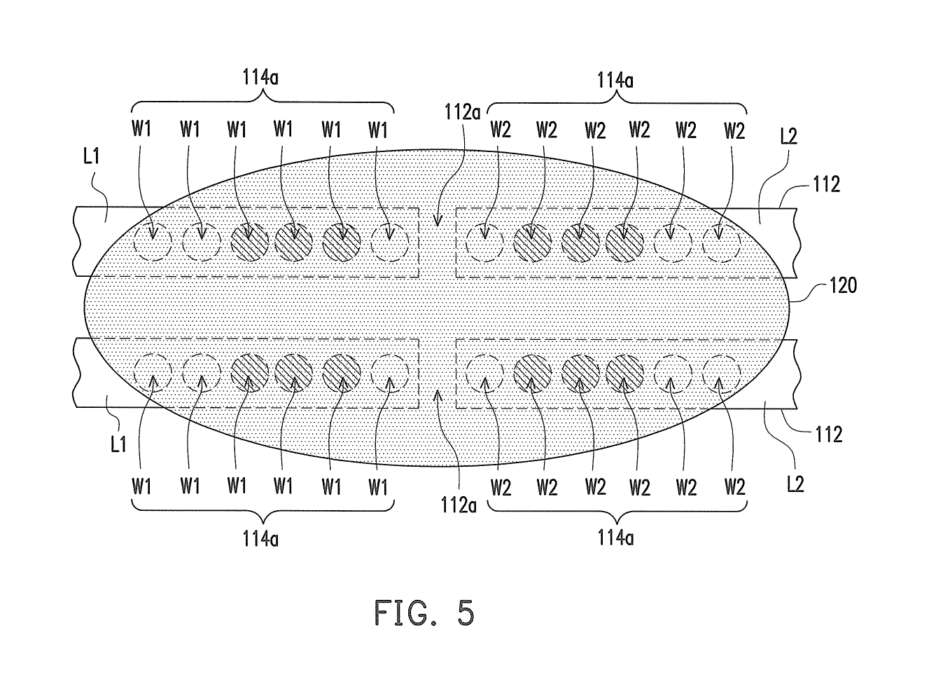

In an embodiment of the invention, the method of forming the conductive adhesive 120 in the repair method can further include a step of foaming the conductive adhesive 120 that covers the open defects 112a of two conductive lines 112 (shown in FIG. 5), given that two of the conductive lines 112 have adjacent open defects 112a (shown in FIG. 3). A portion of the conductive adhesive 120 is then removed to form the cutting trench 122 between the two conductive lines 112, and thereby short circuit between the two conductive lines 112 because of the conductive adhesive 120 can be prevented. In this embodiment, the cutting trench 122 is formed by laser cutting, for instance, which is however not limited in this invention.

In light of the foregoing, the display apparatus and the repair method adapted to the display apparatus as described in this invention at least have following advantages. First, in the display panel, when at least one of the conductive lines has the open defect, the dielectric layer has at least three repair vias whose locations correspond to the open defect, and the repair vias expose the conductive line having the open defect. Therefore, when the conductive adhesive is disposed corresponding to a location of the open defect, the conductive adhesive can be electrically connected to the conductive line having the open defect through the repair vias, so as to repair and conduct the conductive line having the open defect.

Moreover, the dielectric layer has at least three repair vias whose locations correspond to the open defect of the conductive line, and the repair vias are formed by performing the laser drilling process, for example. Hence, even though the laser drilling process cannot be stably performed, or the dielectric layer covering the conductive lines has uncertain thickness, the conductive line having the open defect can be successfully and precisely repaired.

That is to say, the invention provides the repair method for repairing the conductive line having the open defect. The repair method is adapted to the display apparatus, and the application of the repair method leads to favorable repair yield.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions. Additionally, any embodiment or claim of the invention does not need to attain all of the advantages or features disclosed in the invention. The abstract and title are merely used for facilitating the search for patent documents, and the scope of the invention is not limited thereto.

What is claimed is:

1. A display apparatus comprising:
a display panel having a plurality of conductive lines and a dielectric layer covering the conductive lines, wherein at least one of the conductive lines has an open defect, the dielectric layer has at least three repair vias, locations of the repair vias correspond to the open defect, and the at least one of the conductive lines having the open defect is exposed by at least parts of the repair vias; and
a conductive adhesive disposed corresponding to a location of the open defect and electrically connected to the at least one of the conductive lines having the open defect through the repair vias.

2. The display apparatus as claimed in claim 1, wherein the at least one of the conductive lines having the open defect comprises a first line segment and a second line segment separated from each other at the location of the open defect, the repair vias comprises m first repair vias and n second repair vias, the m first repair vias expose the first line segment, the n second repair vias expose the second line segment, and m+n≧3.

3. The display apparatus as claimed in claim 2, wherein m=1 and n>1.

4. The display apparatus as claimed in claim 2, wherein m>1 and n>1.

5. The display apparatus as claimed in claim 1, wherein the at least one of the conductive lines having the open defect has areas exposed by the at least parts of the repair vias, and the exposed areas are substantially the same.

6. The display apparatus as claimed in claim 1, wherein the at least one of the conductive lines having the open defect has areas exposed by the at least parts of the repair vias, and the exposed areas are different.

7. The display apparatus as claimed in claim 1, wherein the display panel has a display region and a circuit bonding region located outside the display region, and the conductive lines extend from the display region to the circuit bonding region.

8. The display apparatus as claimed in claim 1, wherein the repair vias have different depths, the locations of the repair vias correspond to the open defect, and at least parts of the repair vias have the depth greater than a thickness of the dielectric layer.

9. The display apparatus as claimed in claim 8, wherein the repair vias close to the open defect have greater depths, and the repair vias away from the open defect have smaller depths.

10. The display apparatus as claimed in claim 8, wherein the thickness of the dielectric layer is D1, a thickness of the at least one of the conductive lines having the open defect and the thickness of the dielectric layer is D2 in total, and the depths of the at least parts of the repair vias range from D1 to D2.

11. The display apparatus as claimed in claim 10, wherein the depths of the at least parts of the repair vias are smaller than D1.

12. The display apparatus as claimed in claim 10, wherein the depths of the at least parts of the repair vias are substantially equal to D2.

13. The display apparatus as claimed in claim 1, wherein the display panel comprises a liquid crystal display panel, an organic electro-luminescent display panel, a plasma display panel, an electro-phoretic display panel, or an electro-wetting display panel.

14. The display apparatus as claimed in claim 1, wherein the repair vias are arranged along an extending direction of the at least one of the conductive lines having the open defect.

15. The display apparatus as claimed in claim 1, wherein the conductive adhesive covers the repair vias.

16. The display apparatus as claimed in claim 1, wherein the conductive adhesive comprises a thermal-curable conductive adhesive or a photo-curable conductive adhesive.

17. The display apparatus as claimed in claim 1, wherein two adjacent conductive lines of the conductive lines have the open defects adjacent to each other, the conductive adhesive covers the adjacent open defects of the two adjacent conductive lines, and the conductive adhesive has a cutting trench between the two adjacent conductive lines to prevent the two adjacent conductive lines from being electrically connected to each other through the conductive adhesive.

18. A repair method suitable for a display panel, the display panel having a plurality of conductive lines and a dielectric layer covering the conductive lines, at least one of the conductive lines having an open defect, the repair method comprising:
forming at least three repair vias in the dielectric layer, locations of the repair vias corresponding to the open defect, such that the at least one of the conductive lines having the open defect is exposed by the repair vias; and
forming a conductive adhesive at a location corresponding to the open defect, such that the conductive adhesive is electrically connected to the at least one of the conductive lines having the open defect through the repair vias.

19. The repair method as claimed in claim 18, wherein a method of forming the repair vias comprises performing a laser drilling process.

20. The repair method as claimed in claim 19, wherein a method of forming the repair vias comprises:
sequentially modulating power of laser used in the laser drilling process to form the repair vias along an extending direction of the at least one of the conductive lines having the open defect.

21. The repair method as claimed in claim 19, wherein a method of forming the repair vias comprises:
modulating an area irradiated by laser in the laser drilling process to form the repair vias along an extending direction of the at least one of the conductive lines having the open defect, wherein the repair vias have different dimensions.

22. The repair method as claimed in claim 18, wherein a method of forming the repair vias comprises:
forming the repair vias in the dielectric layer at the location corresponding to the open defect, wherein at least parts of the repair vias have a depth greater than a thickness of the dielectric layer.

23. The repair method as claimed in claim 22, wherein the depths of the repair vias are different.

24. The repair method as claimed in claim 18, wherein two of the conductive lines have the open defects adjacent to each other, and a method of forming the conductive adhesive comprises:
forming the conductive adhesive covering the open defects of the two conductive lines; and
removing a portion of the conductive adhesive to form a cutting trench between the two conductive lines, so as to prevent the two conductive lines from being electrically connected to each other through the conductive adhesive.
